(19) United States
(12) Patent Application Publication
(10) Pub. No.: US 2003/0072516 A1
(43) Pub. Date: Apr. 17, 2003

(54) Optical device having an adjustable gain and a method of dynamically adjusting the gain of an optical device

(75) Inventors: Casimer M. DeCusatis, Poughkeepsie, NY (US); Lawrence Jacobowitz, Wappingers Falls, NY (US)

Correspondence Address: Steven Fischman, Esq., Scully, Scott, Murphy & Presser, 400 Garden City Plaza, Garden City, NY, 11530, US

(73) Assignee: INTERNATIONAL BUSINESS MACHINES CORPORATION, ARMONK, NY

(21) Appl. No.: 09/975,267

(22) Filed: Oct. 11, 2001

(51) Int. Cl. G02B 6/28; G02B 6/26

(52) U.S. Cl. 385/15; 385/24

(57) ABSTRACT

An optical gain device, such as an optical amplifier or an optical repeater, and a method for dynamically adjusting the gain of an optical gain device fast enough to propagate OFC signals. The invention utilizes an active feedback control loop combined with an 1 input power monitor which can respond very quickly to changes in the input power and reduce the gain of the device without turning off the pump laser. Preferably, the gain is reduced by a wavelength-locked loop, used to detune the pump laser center wavelength from the passband of an optical bandpass filter.

### BACKGROUND OF THE INVENTION

1. Field of the Invention

This invention generally relates to optical devices having adjustable signal gains. More specifically, the invention relates to such optical, such as optical amplifiers and optical repeaters, that are particularly well suited for Open Fiber Control (OFC) propagation through wavelength multiplexed networks.

2. Discussion of the Prior Art

Wavelength Division Multiplexing (WDM) and Dense Wavelength Division Multiplexing (DWDM) are light-wave application technologies that enable multiple wavelengths (colors of light) to be paralleled into the same optical fibers with each wavelength potentially assigned its own data. Using WDM is the only practical, cost effective way to implement a Geographically Dispersed Parallel System (GDPS), which is strategic to disaster recovery and high performance computing applications. Parallel Systems use InterSystem Channel (ISC) coupling links to interconnect processors with coupling facilities. This requires that the WDM solution support propagation of the Open Fiber Control (OFC) protocols, a handshaking protocol used for linking initialization on ISC 1 and 2 and also supported in compatibility mode on ISC 3 channels. In addition to the sue of ISC channels in a GDPS, there are other applications which can make use of Open Fiber Control protocols, such as channel extenders or repeaters for American National Standards (ANSI) Fibre Channel Standard links, commonly used for storage area networking applications. Although OFC is defined in the ANSI Fibre Channel Standard, it is only a point-to-point protocol and does not describe implementation in a link with multiple segments.

It is desirable to extend GDPS distances to over 100 km; this requires optical amplifiers on the WDM network. However, a new problem arises when one attempts to propagate OFC through a WDM network with optical amplifiers. An optical amplifier will always generate some light output, even when there is no input signal to be amplified; this noise is the result of random, spontaneous emission of photons from the amplifier pump which are subsequently amplified and travel through the WDM network to an endpoint where they may be mistaken for a valid signal. In order to propagate OFC signals through an optical amplifier, the amplifier light output must turn off completely when the input signal is not present; this requires some method of turning down the pump gain so that no spontaneous emission occurs. The gain must then be quickly be turned back on when the input signal is restored; the gain must be modulated fast enough to keep up with the OFC pulses, typically a series of 650 microsecond pulses on a 10 second period. Today, amplifiers cannot tune their gain quickly enough to propagate OFC signals.

Open fiber control (OFC) is a laser eye safety interlock implemented in the transceiver hardware; a pair of transceivers connected by a point-to-point link must perform a handshake sequence in order to initialize the link before data transmission occurs. Only after this handshake is complete will the lasers turn on at full optical power. If the link is opened for any reason (such as a broken fiber or unplugged connector) the link detects this and automatically deactivates the lasers on both ends to prevent exposure to hazardous optical power levels. When the link is closed again, the hardware automatically detects this condition and reestablishes the link. The IBM ISC links, also known as HiPerLinks, for example, use OFC timing corresponding to a 266 Mbit/s link in the ANSI standard, which allows for longer distances at the higher data rate of 1.06 Gigabit per second. OFC is defined for various laser wavelengths and data rates in the ANSI Fibre Channel Standard; the OFC timing and state machine are also defined in this standard. It may be noted that OFC is still required to interoperate with other devices attached to the fiber links, even in those cases where it no longer serves a laser safety function.

OFC was designed for a point-to-point link only, with no intermediate repeaters, multiplexers, or amplifiers to extend the channel distance. This is illustrated in FIG. 1, which shows a duplex OFC link as defined by ANSI. In particular, FIG. 1 shows OFC chips 3 and 4, and transceivers 5 and 6 interconnected by a duplex fiber optic link 7. The ANSI standards do not describe how to propagate OFC through any type of repeater or intermediate box, and commercially available repeaters do not support OFC. It is desirable to accommodate such devices in the design of modern data communication networks. Previous work has described various methods for implementing OFC propagation along a link with optical repeaters, which uses transceivers to periodically regenerate the signal by converting from optical to electrical, amplifying, and retransmitting as optical again (see for example C. DeCusatis and E. Hall, “Method for open fiber control propagation in multi-link fiber optic connections,” IBM patent application P0998-0106 (October 1998), C. DeCusatis and E. Hall, “System for open fiber control propagation in multi-link fiber optic connections,” IBM patent application P0998-0120 (October 1998), C. DeCusatis and E. Hall, “Open fiber control propagation in multi-link fiber optic connections,” IBM patent application P0998-0121 (October 1998), and C. DeCusatis, T. Gregg, and D. Stigliani, “Facility for initializing a fiber optic data link in one mode of a plurality of modes”, IBM patent application POU92-0000053US1 (May 2000).

However, none of this prior work can be applied to the case of all-optical amplifiers used in OFC links. All-optical amplifiers such as doped fiber amps produce amplified spontaneous emission (ASE) noise; photons are spontaneously emitted within the doped fiber, and some of these at the proper wavelength may be captured and propagate along the fiber, acting as noise for the desired signal. Because of the nature of optical amps, even when their input is zero (no light) there is always some output light due to ASE. This condition can be suppressed in systems which use optical to electrical conversion, since the output transmitter can be disabled when there is no input. This cannot be done with optical amps, meaning that at present these amps cannot propagate OFC signals.

In order to propagate an OFC pulse, the optical amp must be able to reduce its output to zero (no light) and back again fast enough to keep up with the industry standard OFC timing signals. The amplifier gain can be reduced by varying the pump power; if the pump were turned off, the gain would be zero and the signal would pass through the amplifier unaffected. Thus, if we were able to simply turn off the pump laser for the low portions of an OFC pulse and turn it back on for the high portions, we could propagate the signal in much the same manner as an optical to electrical repeater. However, the pump laser cannot be turned on and off quickly; the pump laser creates a population inversion in the fiber amp, so that an incoming signal produces stimulated photon emission and gain. There are time constants associated with creating this population inversion and with turning the laser on or off; because of the relatively tight timing requirements on OFC signals, this method is not workable.

Even links which do not implement OFC protocols must sometimes propagate a loss of light (LOL) condition along the length of the fiber. In some cases this can also be complicated by ASE in optical amps. Propagating loss of light is not the same as sending a long string of zero data on the link; the attached computer equipment must be able to determine the difference between an open optical connection and a long run of zeros (potentially corrupted data) since the error recovery is different in each case.

### SUMMARY OF THE INVENTION

An object of this invention is to improve optical devices.

Another object of the present invention is to dynamically adjust the gain applied by an optical device fast enough to propagate OFC signals.

A further object of this invention is to suppress amplified spontaneous emission in an optical gain device without otherwise affecting operation of the device.

The present invention provides an optical gain device, such as an optical amplifier or an optical repeater, and a method for dynamically adjusting the gain of an optical gain device fast enough to propagate OFC signals. The invention utilizes an active feedback control loop combined with an optical input power monitor which can respond very quickly to changes in the input power and reduce the gain of the device without turning off the pump laser. Preferably, the gain is reduced by a wavelength-locked loop, used to detune the pump laser center wavelength from the passband of an optical bandpass filter.

Further benefits and advantages of the invention will become apparent from a consideration of the following detailed description, given with reference to the accompanying drawings, which specify and show preferred embodiments of the invention.

### BRIEF DESCRIPTION OF THE DRAWINGS

FIG. 1 shows a duplex OFC link

FIG. 2 is a block diagram of an optical amplifier embodying this invention.

FIGS. 3-5 illustrate a series of OFC links.

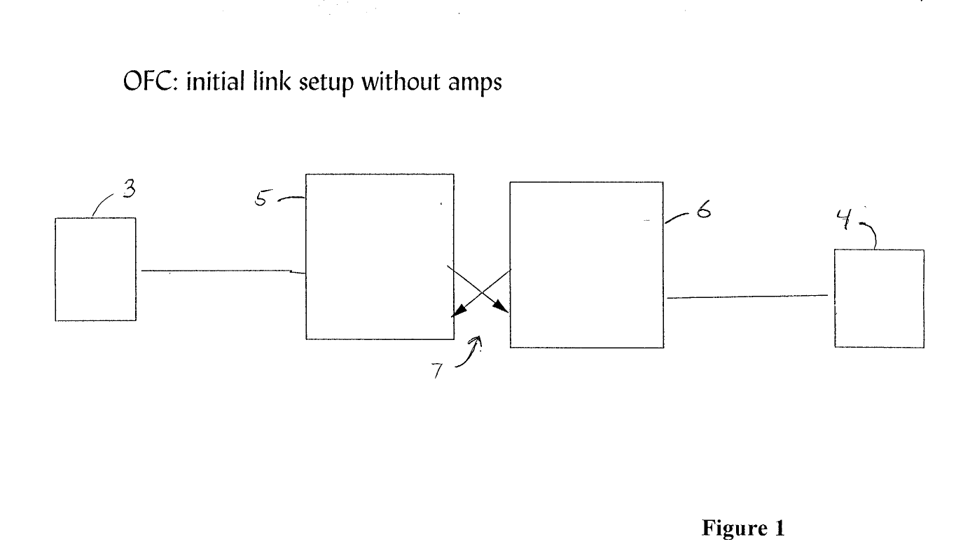

### DETAILED DESCRIPTION OF THE PREFERRED EMBODIMENTS

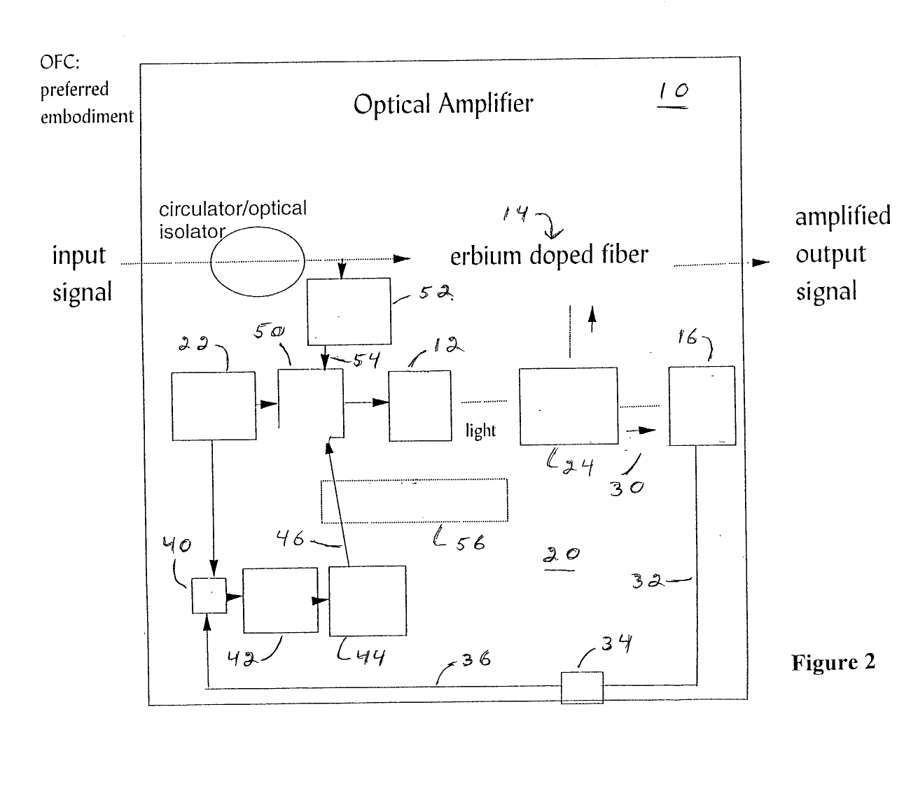

A block diagram of the invention is shown in FIG. 2. The mechanism for an optical amplifier 10 includes a 980 nm laser pump diode 12, which is optically filtered and feeds into an erbium doped fiber amplifier (EDFA) 14. This creates a population inversion, which optically amplifies an incident signal at the correct wavelength. To tune the amplifier gain, we monitor a small fraction of the signal, say 5% or less, with a monitor photodiode 16. Note that multiple wavelengths may be monitored with a single diode, as the net average optical power is of interest. The amplifier gain is controlled by a feedback loop 20, which may use dither modulation 22 to lock the pump diode center wavelength to the middle of the pump filter passband. When an OFC pulse enters the amplifier, the resulting fluctuation in optical power is detected by the monitor photodiode 16 and generates an electrical signal which feeds into the pump diode control loop. This instructs the feedback loop to deliberately detune the pump diode center wavelength from the passband of filter 24, effectively modulating the optical power of the pump diode.

More specifically, the filter 24 is designed to tap off a small amount of light 30 which is incident upon photo detector receiver device, e.g., P-I-N diode 16, and converted into an electrical feedback signal 32. The amount of light that may be tapped off may range anywhere between one percent (1%) to five percent (5%) of the optical output signal, for example, however, skilled artisans will appreciate that other amounts of laser light above the noise level that retain the integrity of the output signal including the dither modulation characteristic, may be tapped off. The remaining laser light passes on through the filter 24 to the erbium doped fiber.

As the PIN diode output 32 is a relatively weak electric signal, the resultant feedback signal is amplified by amplifier device 34 to boost the signal strength. The amplified electric feedback signal 36 is input to a multiplier device 32 where it is combined with the original dither modulation signal. The cross product signal 34 that results from the multiplication of the amplified PIN diode output (feedback signal) and the dither signal includes terms at the sum and difference of the dither frequencies. The result is thus input to a low pass filter device 42 where it is low pass filtered and then averaged by integrator circuit 44 to produce a signal 46 which is positive or negative depending on whether the laser center wavelength is respectively less than or greater than the center point of the bandpass filter.

This signal 46 is then used to adjust the dither modulation of the laser diode, adjusting its center wavelength to become misaligned with, or to become better aligned with the center wavelength of the optical filter 24. In particular, the signal 46 may be applied to the laser bias voltage device 50, where it may be added (e.g., by an adder device, not shown) in order to correct the laser bias current 46 in the appropriate direction. In this manner, the bias current (and laser wavelength) can increase or decrease to misalign, or to better align, that wavelength with the center of the filter passband. Alternately, the signal 46 may be first converted to a digital form, prior to being applied to the bias voltage device 50. Elements of a feedback loop are described in greater detail in copending application No. 09/865,256 for “Apparatus and Method for Wavelength-Locked Loop for Systems and Applications Employing Electromagnetic Signals,” filed May 22, 2001, the disclosure of which is hereby incorporated herein in its entirety by reference.

Amplifier 10 thus includes an active feedback control loop combined with an optical input power monitor which can respond very quickly to changes in the amplifier input power and reduce the amplifier gain without turning off the pump laser. The gain is reduced by a wavelength feedback loop, used to detune the pump laser center wavelength from the passband of an optical bandpass filter. As shown in FIG. 2, the amp input is monitored by an optical splitter and photodiode 52, used to determine when the incident link is opened for any reason (for example, due to a break in the fiber or an opened connection point). When input to the amp goes to zero, so does the input photodetector signal 54; this signal enables the feedback loop to reduce the amp gain to zero and inhibit the output light. Note that the pump laser is modulated at a low frequency (a few kHz or less) in wavelength by varying its bias current (alternate ways of changing the laser wavelength may also be used, including thermal adjustments).

By passing the light through an optical filter 24, the resulting output pump light has a small intensity modulation, too weak to influence operation of the optical amp. A sample (5%) of this light is redirected to a photodetector 16, whose output is proportional to the intensity modulation. This signal is then multiplied by the original pump modulation signal, to create a vector cross product; when integrated, this provides a control signal for the pump laser. The control signal is zero if the pump laser and filter center wavelengths are aligned (the vector cross product is frequency doubled in this case). If the laser is misaligned with the filter, then this signal provides both the magnitude and direction in which the laser wavelength must be changed to bring them into better alignment.

The laser bias is controlled by a digital circuit, whose inputs include this control signal 46 and the input monitor signal 54. When the amp input is high, the pump laser is kept aligned to the filter, the gain is optimized, and the amp functions normally. When the amp input is low (no light), this is detected by the input monitor 52 and the pump laser wavelength is tuned far off center with the filter 24. The filter output drops quickly to zero, and so does the amp gain; the amp output is now the same as its input, which is zero.

When an OFC pulse signal comes along the link from the input side, the monitor diode 52 detects the leading and trailing edges of the OFC pulse and turns the pump power on and off again by tuning and detuning alignment between the pump laser and filter center wavelengths. In this way, the amp will have gain for a short period corresponding to the duration of the OFC pulse; the OFC pulse is amplified and passes through the amp with gain but without a substantial change in its rise or fall times or its width. Because the amp can respond fast enough to keep up with OFC signals, the OFC pulses are not distorted; it is important to note this is possible because the invention keeps the pump laser on at all times, so it is not necessary to wait for the laser turn on/off delays (this has the additional benefit of improving the lifetime of the pump laser).

A similar apparatus in the opposite direction of the link handles the handshake OFC signal, so the amps will allow OFC protocols to operate through amplifiers at distances much longer than previously possible (up to hundreds of km). An optional or alternate embodiment involves using additional control electronics 56 to adapt the amount of gain for different types of OFC signals. For example, the OFC signal may use multiple light intensity levels instead of a binary pulse; the feedback signal can be adjusted to tune the laser wavelength to intermediate alignment positions with the filter, and regulate the amp gain if required to follow the contours of the input pulse.

It should be noted that, although the present invention has been described above as embodied in an optical amplifier, the invention may be embodied in other types of optical devices having adjustable signal gain. For instance, the invention may be embodied in optical repeaters.

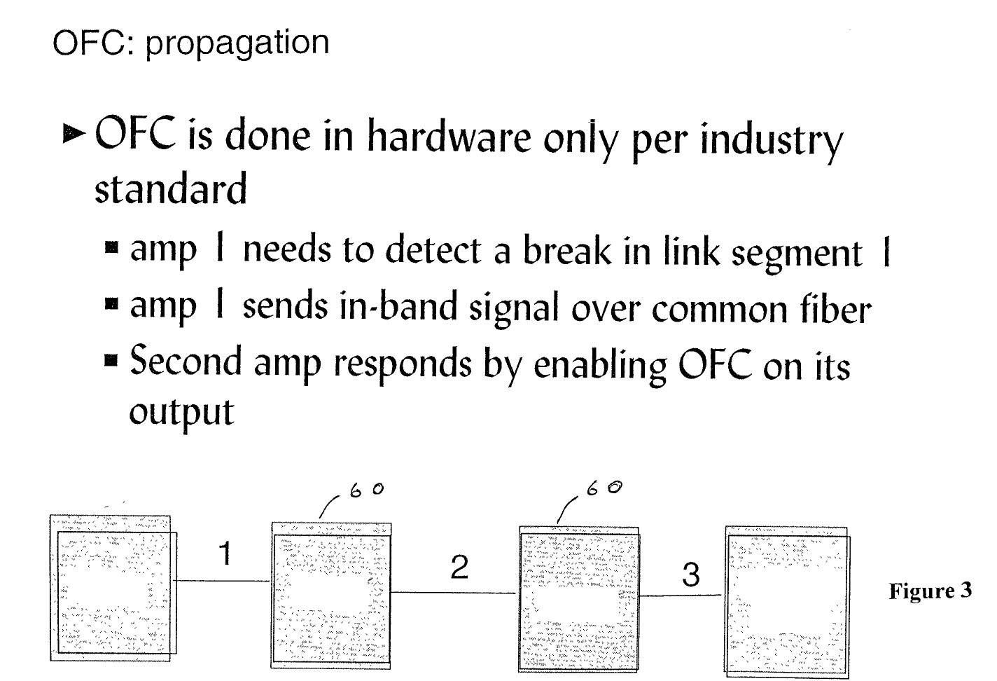

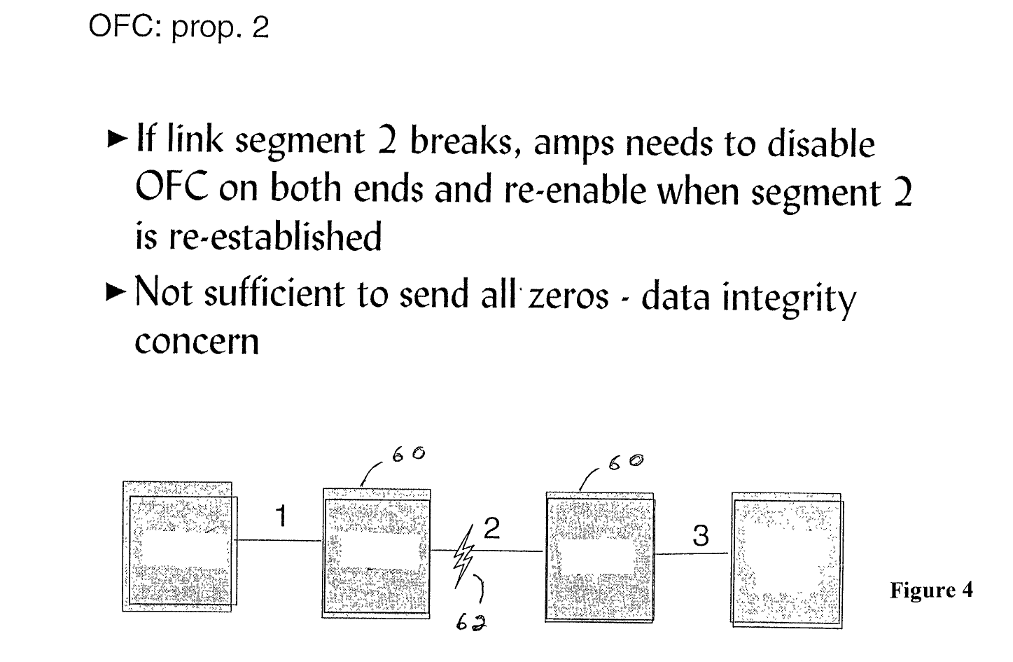

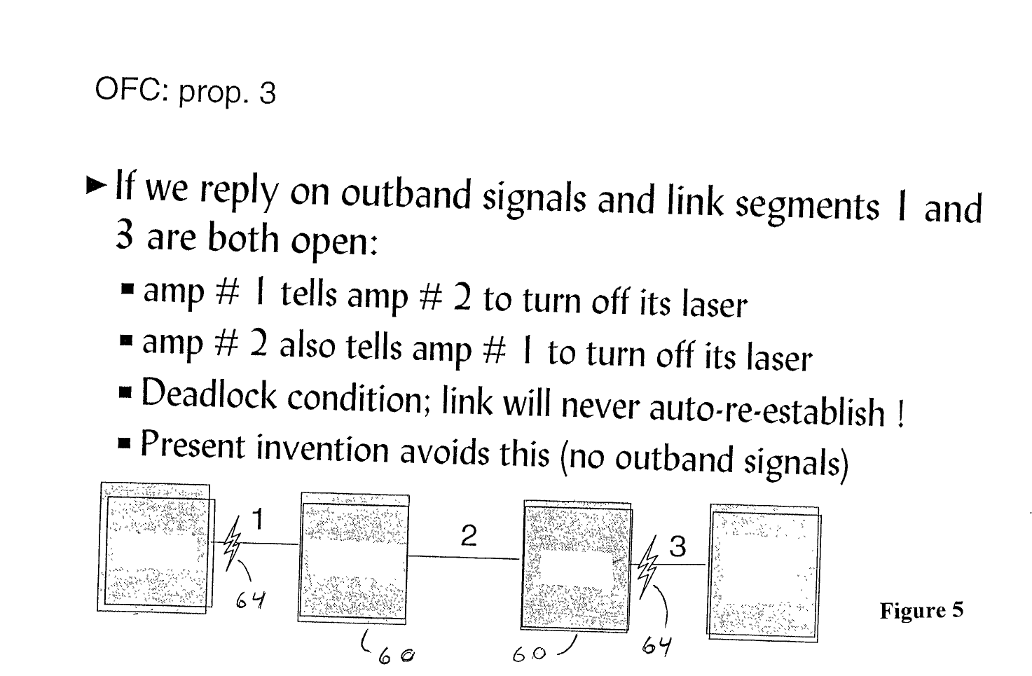

In addition, it may be noted that this invention may be used to avoid so-called “deadlock” problems in OFC propagation. This is illustrated in FIGS. 3-5; inserting a repeater or amplifier 60 in an OFC link effectively divides the link into 3 discrete segments, yet the protocols demand that it function as a single long virtual cable. A break in any link segment, for example as illustrated at 62 in FIG. 4 or at 64 in FIG. 5, must be propagated to both ends of the link. If we rely on another mechanism, such as outband control of the amps, to do this, the result can be a deadlock situation as depicted in FIGS. 4 and 5. The present invention handles OFC in a native attach mode without any outside intervention on the link, and thus avoids this problem.

Open fiber control propagation provides a number of important advantages. One advantage of this invention is that it allows all devices, processors, and repeaters attached to a communication channel with multiple link segments to be aware when a link segment opens and physical connectivity is lost. This is important because fiber optic links can use open fiber control as a means of detecting whether there is physical connectivity on a communications link. If open fiber control is not propagated through repeaters/multiplexers to all link segments, then attached devices will not “know” that they have lost connectivity with the attached systems. This has several important consequences: For instance, if a host does not realize that it is no longer connected with an attached device, then it cannot report the error to a service console so that repair actions can be initiated. Also, the host will continue trying to send data to the attached device. Because there is no physical path, the data never arrives and the attached device never sends an acknowledgment of receiving the data. Failing to receive proper acknowledgments, the host could continue retrying to send the same data over and over again, which ties up the processor and keeps the host from doing any useful work. Also, if the attached device is a storage media such as disk, tape, etc. data could be lost if the host is unable to communicate with the attached device.

Also, if two processors are sharing the same database and the link to one of the processors is broken, then the processor that is still attached will continue to update the database without notifying the other processor. In this manner, data that one processor needs may be overwritten by the first processor and lost. Or, one processor could update the database and the second processor would not be aware of this update; operations which need to execute sequentially would lose synchronization between the two processors. This is generally known as a data integrity problem.

This invention prevents all of the above situations from occurring. A related advantage is that the invention allows integrity of all link segments to be monitored from a single location.

Another advantage is that the invention complies with industry standard timings for open fiber control, as specified by the ANSI Fibre Channel Standard. This means that the invention will interoperate with any device built by multiple vendors in the industry. Another advantage is that the invention can be implemented in hardware only, which makes the processing time faster and simplifies the implementation since there are fewer things which can fail. Another advantage is that one embodiment of the invention allows OFC propagation without making any changes to the hardware of the attached devices, only the repeaters, so the device can interoperate with legacy systems already in the field. Another advantage is that the invention prevents deadlock conditions in which the link does not automatically restore itself because different repeaters are continually signaling each other to turn off link segments.

Another advantage is that the invention automatically restores physical connectivity when any open link segment is closed again. Another advantage is that one embodiment of the invention applies to both repeaters (single input/output) and multiplexers (multiple inputs/single output) for any link which uses OFC at any data rate. Another advantage is that the invention can be extended to any number of repeaters in a daisy chain arrangement. Another advantage is that propagation of OFC does not require a separate wire, fiber, or communications path between the repeaters and attached devices; all communication is carried out over the existing duplex fiber optic links. Another advantage is that using the invention does not violate existing laser safety certifications (FDA and IEC 825) on the attached devices or repeaters.

Another advantage is that this invention enables the construction of repeaters for OFC links, therefore it allows the construction of extended distance parallel computer processing installations which rely on fiber optic links with OFC to interconnect multiple processors. It is desirable for the processors in a Parallel System to be located at long distances from each other for disaster recovery purposes; in the event of a system failure at one location, the other location could continue running uninterrupted (continuous system availability assumes that it is far enough away to not be affected by the disaster). Examples of disasters include earthquakes, floods, power failures, etc.

Another advantage is that by applying the invention to multiplexers, it becomes possible to construct parallel computer processing installations at extended distances without requiring large numbers of optical fibers between the locations. A parallel computer processing installations can require between 10 and hundreds of links between two distant locations; multiplexers reduce the number of inter-site links by combining many data channels over one physical link. Reducing the number of inter-site links both simplifies the installation and greatly reduces the cost of installing fiber.

Another advantage of the invention is that the embodiments using outband signals specify that the outband signal be both disparity balanced and DC balanced. This keeps the optical receivers from drifting out of specification during a loss of light condition, so that the link can re-initialize quickly when connectivity is restored. Another advantage of the invention is that it does not require any special data characters or sequences to convey the loss of light state across the link, so it is not necessary to modify the software running over the link to reserve special control sequences or characters for this condition.

While it is apparent that the invention herein disclosed is well calculated to fulfill the objects previously stated, it will be appreciated that numerous modifications and embodiments may be devised by those skilled in the art, and it is intended that the appended claims cover all such modifications and embodiments as fall within the true spirit and scope of the present invention.

1. An optical device having an adjustable optical signal gain, the device, comprising:
an input for receiving an input optical signal;
mechanism for amplifying the optical signal and outputting the amplified optical signal from the device;
a monitor for monitoring the power of the input optical signal; and
a control loop for adjusting the amplification gain of the input optical signal when the monitor senses a predefined fluctuation in the power of the optical signal.

2. An optical device according to claim 1, wherein the device is used for transporting Open Fiber Control protocol.

3. An optical device according to claim 2, wherein:
said mechanism includes a pump laser for generating a laser signal, and a circuit for applying the laser signal to control the amplifier gain; and
in response to the monitor sensing the predefined fluctuation in the power of the optical signal, the control loop modifies the laser signal to reduce the amplifier gain without turning off the pump laser.

4. An optical device according to claim 3, wherein the monitor applies a portion of the input optical signal to vary the intensity of the laser signal.

5. An optical device according to claim 3, wherein the control loop includes:
an optical filter for receiving the laser signal and for directing a first portion of the laser signal onto a first path to cause said mechanism to amplify the input optical signal; and
a feedback circuit for receiving a second portion of the laser signal from the filter, and for using said second portion to modify the laser signal to adjust the amplifier gain.

6. An optical device according to claim 5, wherein:
the laser signal has a center wavelength;
the filter implements a peaked passband function including a center wavelength; and
the feedback circuit uses said second portion of the laser signal to misalign the center wavelengths of the laser signal and the optical filter.

7. An optical device according to claim 1, wherein the control loop reduces the amplifier gain when the monitor senses a decrease of more than a given value in the power of the input optical signal.

8. An optical device according to claim 1, wherein the control loop reduces the amplifier gain substantially to zero when the monitor senses the predefined fluctuation in the power of the input optical signal.

9. An optical device according to claim 1, wherein the control loop increases the amplifier gain when the monitor senses a predetermined fluctuation in the power of the input optical signal.

10. An optical device according to claim 9, wherein the control loop increases the amplifier gain when the monitor senses an increase of more than a given value in the power of the input optical signal.

11. A method of adjusting the gain of an optical device, comprising the steps:
providing an optical device having an adjustable amplification gain;
said device receiving an input optical signal;
said device amplifying the optical signal and outputting the amplified optical signal from the device;
monitoring the power of the input optical signal; and
adjusting the amplification gain when the monitor senses a predefined fluctuation in the power of the input optical signal.

12. A method according to claim 11, further comprising the step of using the device for transporting Open Fiber Control protocol.

13. A method according to claim 11, wherein:
the device includes a pump laser for generating a laser signal, and a circuit for applying the laser signal to control the amplification gain; and
the adjusting step includes the step of modifying the laser signal, in response to the monitor sensing the predefined fluctuation in the power of the input optical signal, to reduce the amplification gain without turning off the pump laser.

14. A method according to claim 13, wherein the monitoring step includes the step of applying a portion of the input optical signal to vary the intensity of the laser signal.

15. A method according to claim 13, wherein the circuit includes:
an optical filter for receiving the laser signal and for directing a first portion of the laser signal onto a first path to cause said device to amplify the optical signal; and
the adjusting step includes the steps of receiving a second portion of the laser signal from the filter, and using said second portion to modify the laser signal to adjust the amplification gain.

16. A method according to claim 15, wherein:
the laser signal has a center wavelength;
the filter implements a peaked passband function including a center wavelength; and
the using step includes the step of using said second portion of the laser signal to misalign the center wavelengths of the laser signal and the optical filter.

17. A method according to claim 13, wherein the adjusting step includes the step of reducing the amplifier gain substantially to zero when a decrease of more than a given value is sensed in the power of the input optical signal.

18. A method according to claim 13, wherein the adjusting step includes the step of increasing the amplification gain when a predetermined increase is sensed in the power of the input optical signal.
